(19) United States
(12) Patent Application Publication
(10) Pub. No.: US 2023/0342627 A1
(43) Pub. Date: Oct. 26, 2023

(54) AUTOMATED LOOKBACK WINDOW SEARCHING

(71) Applicant: INTERNATIONAL BUSINESS MACHINES CORPORATION, Armonk, NY (US)

(72) Inventors: Long VU, Chappaqua, NY (US); Saket K SATHE, Armonk, NY (US); Peter Daniel KIRCHNER, Putnam Valley, NY (US); Gregory BRAMBLE, Larchmont, NY (US)

(73) Assignee: INTERNATIONAL BUSINESS MACHINES CORPORATION, Armonk, NY (US)

(21) Appl. No.: 17/660,369

(22) Filed: Apr. 22, 2022

(51) Int. Cl. G06N 5/00; G06N 5/02

(52) U.S. Cl. CPC G06N 5/003; G06N 5/022

(57) ABSTRACT

Predefined pipelines may be created with predefined meta-features. Time series data may be segmented using lookback window parameters. Meta-features may be determined for windowed data. Those of the predefined pipelines having a maximum amount of matching predefined meta-features may be determined. Those of the lookback window parameters that result in the windowed data having the meta-features most similar to the meta-features of one or more of the plurality of predefined pipelines may be identified.

### BACKGROUND

The present invention relates in general to computing systems, and more particularly, to various embodiments for providing enhanced lookback window searching in a computing system using a computing processor.

### SUMMARY

According to an embodiment of the present invention, a method for providing enhanced lookback window searching for time series automated artificial intelligence (“AI”) machine learning (“ML”) systems (“AutoAI systems” or automated machine learning systems “auto ML system”) in a computing environment, by one or more processors, in a computing system. Predefined pipelines may be created with predefined meta-features. Time series data may be segmented using lookback window parameters. Meta-features may be determined for windowed data. Those of the predefined pipelines having a maximum amount of matching predefined meta-features may be determined. Those of the lookback window parameters that result in the windowed data having the meta-features most similar to the meta-features of one or more of the plurality of predefined pipelines may be identified.

An embodiment includes a computer usable program product. The computer usable program product includes a computer-readable storage device, and program instructions stored on the storage device.

An embodiment includes a computer system. The computer system includes a processor, a computer-readable memory, and a computer-readable storage device, and program instructions stored on the storage device for execution by the processor via the memory.

Thus, in addition to the foregoing exemplary method embodiments, other exemplary system and computer product embodiments are provided.

### BRIEF DESCRIPTION OF THE DRAWINGS

FIG. 1 is a block diagram depicting an exemplary cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 is an additional block diagram depicting how an exemplary functional relationship between various aspects of the present invention may be realized.

FIG. 5 is a block flow diagram depicting exemplary operations for performing lookback window parameter searching for timeseries automated AI machine learning (“ML”) systems (“AutoAI systems”) in a computing environment by a processor in which aspects of the present invention may be realized.

FIG. 6 is a diagram depicting lookback window parameters in a computing environment by a processor in which aspects of the present invention may be realized.

FIG. 7A is a diagram depicting operations for providing meta feature matching to identify closest matching predefined meta-features and pipeline in a computing environment by a processor in which aspects of the present invention may be realized.

FIG. 7B is a diagram depicting operations for providing meta feature matching to identify closest matched pipeline in a computing environment by a processor in which aspects of the present invention may be realized.

FIG. 8 is a block flow diagram depicting exemplary operation for window length searching in Bayesian optimization in a computing environment by a processor in which aspects of the present invention may be realized.

FIG. 9 is a flowchart diagram depicting an exemplary method for providing enhanced lookback window searching in a computing environment by a processor in a computing environment by a processor, again, in which aspects of the present invention may be realized.

### DETAILED DESCRIPTION OF THE DRAWINGS

The present invention relates generally to the field of artificial intelligence (“AI”) such as, for example, machine learning and/or deep learning. Machine learning allows for an automated processing system (a “machine”), such as a computer system or specialized processing circuit, to develop generalizations about particular datasets and use the generalizations to solve associated problems by, for example, classifying new data. Once a machine learns generalizations from (or is trained using) known properties from the input or training data, it can apply the generalizations to future data to predict unknown properties.

Moreover, machine learning is a form of AI that enables a system to learn from data rather than through explicit programming. A major focus of machine learning research is to automatically learn to recognize complex patterns and make intelligent decisions based on data, and more efficiently train machine learning models and pipelines. However, machine learning is not a simple process. As the algorithms ingest training data, it is then possible to produce more precise models based on that data. A machine-learning model is the output generated when a machine-learning algorithm is trained with data. After training, input is provided to the machine learning model which then generates an output. For example, a predictive algorithm may create a predictive model. Then, the predictive model is provided with data and a prediction is then generated (e.g., “output”) based on the data that trained the model.

Machine learning enables machine learning models to train on datasets before being deployed. Some machine-learning models are online and continuous. This iterative process of online models leads to an improvement in the types of associations made between data elements. Different conventional techniques exist to create machine learning models and neural network models. The basic prerequisites across existing approaches include having a dataset, as well as basic knowledge of machine learning model synthesis, neural network architecture synthesis and coding skills.

In one aspect, automated AI machine learning (“ML”) systems (“AutoAI systems” or automated machine learning systems “auto ML system”) may generate multiple (e.g., hundreds) machine learning pipelines. Designing a machine learning pipeline involves several decisions such as, for example, which data preparation and preprocessing operations should be applied, which machine algorithm should be used with which settings (hyperparameters). AI machine learning systems may automatically search for an approved or satisfactorily performing pipeline. For this purpose, several machine learning pipelines may be selected and trained to convergence. Its performance is estimated on a hold-out set of the data. However, training a machine learning model on an entire dataset, particularly a time series data set, and waiting until convergence is time consuming.

Additionally, the AutoML may be defined as the problem of automatically (without human input) producing test set predictions for a new dataset within a fixed computational budget.

Time-series data is generated in many systems and often forms the basis for forecasting and predicting future events in these systems. For example, in a data-center, a monitoring system could generate tens to hundreds of thousands of time-series data, each representing the state of a particular component (e.g., processor and memory utilization of servers, bandwidth utilization of the network links, etc.). Auto-Regressive Integrated Moving-Average (“ARIMA”) is a class of statistical models used for modeling time-series data and forecasting future values of the time-series. Such modeling and forecasting can then be used for predicting events in the future and taking proactive actions and/or for detecting abnormal trend. Time series analytics is crucial in various types of industries such as, for example in the financial, internet of things (“IoT”), and/or technical industries. Time series may be noisy and complex and require large datasets, significant amount of time and expertise to train meaningful models, if possible.

Thus, challenges arise in training and identifying optimize machine learning pipelines particularly as it relates to time series data. In one aspect, a machine learning pipeline may refer to a workflow including a series of transformers and estimators. As such, identifying and selecting optimized machine learning pipelines are crucial components in automated machine learning systems for time series forecasting. Additionally, in timeseries prediction, a lookback window has a strong impact on model performance. Lookback window parameters may include, for example, a window type, window length, window skip step, prediction horizon, etc. Whenever lookback window parameters change, a new training set is created and causing the pipeline search space to increase significantly, which does not exist in existing AutoAI pipeline searching. The ability to quickly and rapidly search for pipelines that have optimal lookback window parameters for timeseries prediction is crucial. Existing pipeline search techniques for timeseries include, for example, construction-based search process that is very slow (e.g., lookback window parameters and pipeline are constructed, evaluated, ranked during runtime), and decouple tuning lookback window parameters and selecting pipeline, model performance is poor.

Accordingly, a need exist for providing enhanced lookback window searching for time series automated artificial intelligence (“AI”) machine learning (“ML”) systems (“AutoAI systems” or automated machine learning systems “auto ML system”) in a computing environment, by one or more processors, in a computing system. Predefined pipelines may be created with predefined meta-features. Time series data may be segmented using lookback window parameters. Meta-features may be determined for windowed data. Those of the predefined pipelines having a maximum amount of matching predefined meta-features may be determined. Those of the lookback window parameters that result in the windowed data having the meta-features most similar to the meta-features of one or more of the plurality of predefined pipelines may be identified.

In one aspect, meta-features may be characteristics of the dataset that can be computed efficiently and that help us determine which algorithm to use on a new dataset.

In an additional aspect, as used herein, a machine learning pipeline may be one or more processes, operations, or steps to train a machine learning process or model (e.g., creating computing application code, performing various data operations, creating one or more machine learning models, adjusting and/or tuning a machine learning model or operation, and/or various defined continuous operations involving machine learning operations). In addition, a machine learning pipeline may be one or more machine learning workflows that may enable a sequence of data to be transformed and correlated together in a machine learning model that may be tested and evaluated to achieve an outcome. Additionally, a trained machine learning pipeline may include an arbitrary combination of different data curation and preprocessing steps. The machine learning pipeline may include at least one machine learning model. Also, a trained machine learning pipeline may include at least one trained machine learning model.

In one aspect, a machine learning model may be a system that takes as input the curated and preprocessed data and will output a prediction (e.g., the output of all steps that happened before in the machine learning pipeline), depending on the task, and the prediction may be a forecast, a class, and/or a more complex output such as, for example, sentences in case of translation. In another aspect, a machine-learning model is the output generated upon training a machine-learning algorithm with data. After training, the machine learning model may be provided with an input and the machine learning model will provide an output.

In general, as used herein, “optimize” (e.g., best) may refer to and/or defined as “maximize,” “minimize,” or attain one or more specific targets, objectives, goals, or intentions. Optimize may also refer to maximizing a benefit to a user (e.g., maximize a trained machine learning pipeline/model benefit). Optimize may also refer to making the most effective or functional use of a situation, opportunity, or resource.

Additionally, optimizing need not refer to a best solution or result but may refer to a solution or result that “is good enough” for a particular application, for example. In some implementations, an objective is to suggest a “best” combination of preprocessing operations (“preprocessors”) and/or machine learning models/machine learning pipelines, but there may be a variety of factors that may result in alternate suggestion of a combination of preprocessing operations (“preprocessors”) and/or machine learning models yielding better results. Herein, the term “optimize” may refer to such results based on minima (or maxima, depending on what parameters are considered in the optimization problem). In an additional aspect, the terms “optimize” and/or “optimizing” may refer to an operation performed in order to achieve an improved result such as reduced execution costs or increased resource utilization, whether or not the optimum result is actually achieved. Similarly, the term “optimize” may refer to a component for performing such an improvement operation, and the term “optimized” may be used to describe the result of such an improvement operation.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

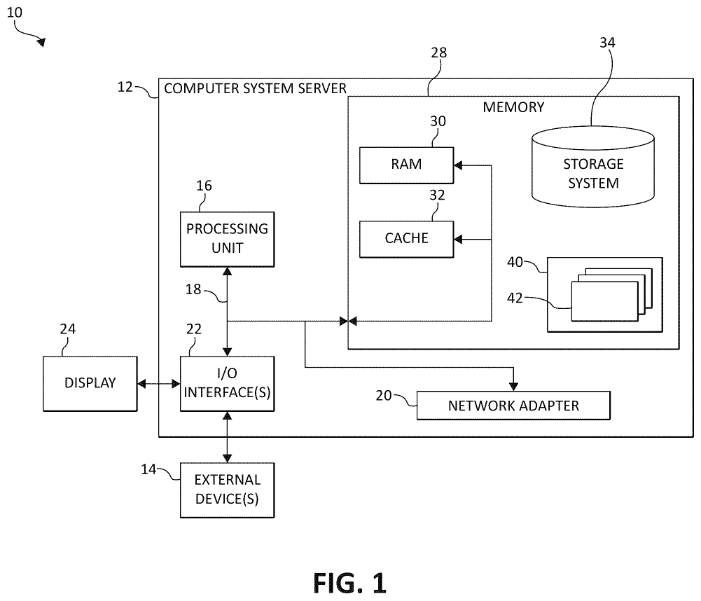

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

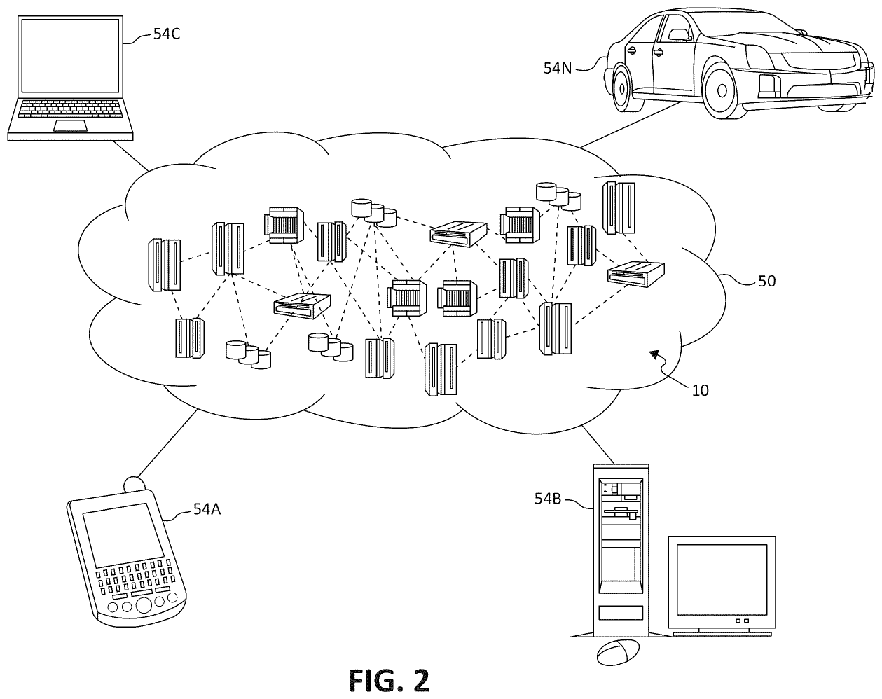

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

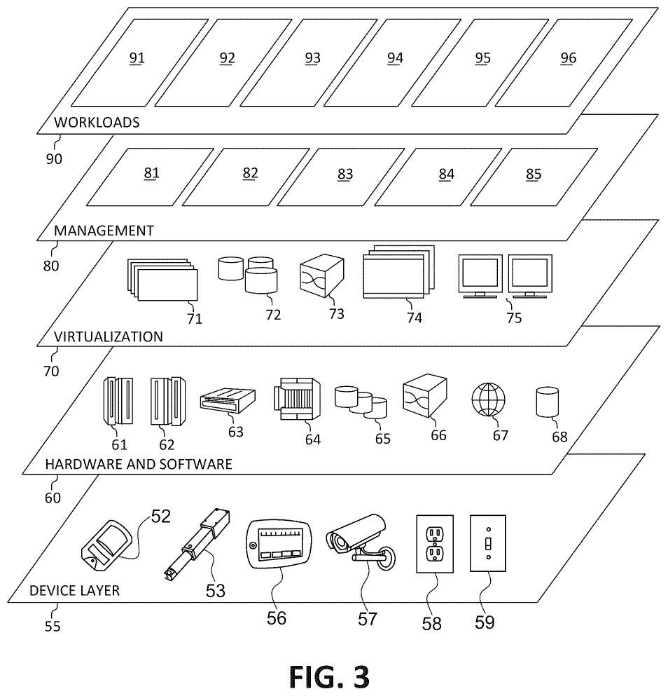

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for providing enhanced lookback window searching in a computing environment. In addition, workloads and functions 96 for providing enhanced lookback window searching in a computing environment may include such operations as analytics, deep learning, and as will be further described, user and device management functions. One of ordinary skill in the art will appreciate that the workloads and functions 96 for providing enhanced lookback window searching in a computing environment may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

As previously stated, the present invention provides novel solutions for providing enhanced lookback window searching in machine learning operations in a computing environment, by one or more processors, in a computing system. Predefined pipelines may be created with predefined meta-features. Time series data may be segmented using lookback window parameters. Meta-features may be determined for windowed data. Those of the predefined pipelines having a maximum amount of matching predefined meta-features may be determined. Those of the lookback window parameters that result in the windowed data having the meta-features most similar to the meta-features of one or more of the plurality of predefined pipelines may be identified.

In some implementations, initially, one or more sets of lookback window parameters can be used to find/identify a predefined pipeline with the closest matched/best matched predefined meta-features. Predefined pipelines and predefined meta-features can be obtained from the log of current AutoAI/AutoML systems or newly created. Lookback window parameters may include window types (e.g., tumbling, sliding, nonoverlapping), window length, window skip step, sub lookback windows with the same right end, and prediction horizon. The lookback window parameters can be searched with different search algorithms such as Randomize search, Bayesian optimization.

Similarity between meta-features can be measured with different metrics such as, for example, KL-divergence. A change of lookback window parameters may lead to change of prediction targets accuracy of selected pipeline. A more accurate predefined pipeline can be selected, given a larger set of input predefined pipelines and predefined meta-features.

Initially, multiple sets of lookback window parameters can be used as follows. First, each set of lookback window parameters may result in one windowed dataset, or one set of metafeatures. Multiple sets of lookback window parameters result in multiple sets of meta-features. The matching of multiple sets of meta-features against all predefined meta-features. A search operation may be executed to improve pipeline performance by finding the optimal lookback window parameters. A performance comparison (e.g., pipeline construction vs. meta-feature matching) may be performed. One or more meta-features can be calculated and matched in order of seconds. Pipeline construction and evaluation may iteratively perform for each set of window parameters, thus the timing for completion may be in the order of hours, depending on the size and complexity of input time series dataset.

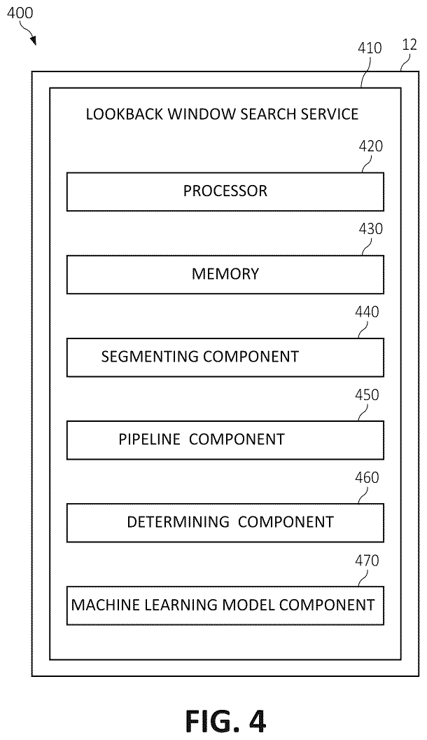

Turning now to FIG. 4, a block diagram depicting exemplary functional components of system 400 for providing enhanced lookback window searching in machine learning operations in a computing environment according to various mechanisms of the illustrated embodiments is shown. In one aspect, one or more of the components, modules, services, applications, and/or functions described in FIGS. 1-3 may be used in FIG. 4. As will be seen, many of the functional blocks may also be considered “modules” or “components” of functionality, in the same descriptive sense as has been previously described in FIGS. 1-3.

A lookback window search service 410 is shown, incorporating processing unit 420 (“processor”) to perform various computational, data processing and other functionality in accordance with various aspects of the present invention. In one aspect, the processor 420 and memory 430 may be internal and/or external to the lookback window search service 410, and internal and/or external to the computing system/server 12. The lookback window search service 410 may be included and/or external to the computer system/server 12, as described in FIG. 1. The processing unit 420 may be in communication with the memory 430. The lookback window search service 410 may include a segmenting component 440, a pipeline component 450, a determining component 460, and a machine learning model component 480.

In one aspect, the system 400 may provide virtualized computing services (i.e., virtualized computing, virtualized storage, virtualized networking, etc.). More specifically, the system 400 may provide virtualized computing, virtualized storage, virtualized networking and other virtualized services that are executing on a hardware substrate.

The lookback window search service 410, using the segmenting component 440, the pipeline component 450, the determining component 460, and/or the machine learning model component 480, may segment timeseries data using lookback window parameters; determine meta-features for windowed data; identify those of a plurality of predefined pipelines having a maximum amount of matching one or more predefined meta-features; and identify those of the lookback window parameters that result in the windowed data having the meta-features most similar to the meta-features of one or more of the plurality of predefined pipelines.

The lookback window search service 410, using the segmenting component 440, the pipeline component 450, the determining component 460, and/or the machine learning model component 480, may create the plurality predefined pipelines with the one or more predefined meta-features.

The lookback window search service 410, using the segmenting component 440, the pipeline component 450, the determining component 460, and/or the machine learning model component 480, may compare the meta-features of the windowed data to identify those of the plurality of predefined pipelines matching the one or more predefined meta-features.

The lookback window search service 410, using the segmenting component 440, the pipeline component 450, the determining component 460, and/or the machine learning model component 480, may use the lookback window parameters to identify those of the plurality of predefined pipelines having a maximum amount of matching one or more predefined meta-features.

The lookback window search service 410, using the segmenting component 440, the pipeline component 450, the determining component 460, and/or the machine learning model component 480, may identify one or more lookback window parameters having windowed data with meta-features similar to thee one or more meta-features.

The lookback window search service 410, using the segmenting component 440, the pipeline component 450, the determining component 460, and/or the machine learning model component 480, may modify one or more of the lookback window parameters too adjust prediction targets.

The lookback window search service 410, using the segmenting component 440, the pipeline component 450, the determining component 460, and/or the machine learning model component 480, may select the one or more of the plurality of predefined pipelines with selected lookback window parameters.

In one aspect, the machine learning component 440 may receive, identify, and/or select a machine learning model and/or machine learning pipeline, a dataset for a data set (e.g., a time series data set) used for testing the machine learning model and/or machine learning pipeline.

In one aspect, the machine learning component 470 as described herein, may perform various machine learning operations using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are within the scope of this disclosure. Also, when deploying one or more machine learning models, a computing device may be first tested in a controlled environment before being deployed in a public setting. Also even when deployed in a public environment (e.g., external to the controlled, testing environment), the computing devices may be monitored for compliance.

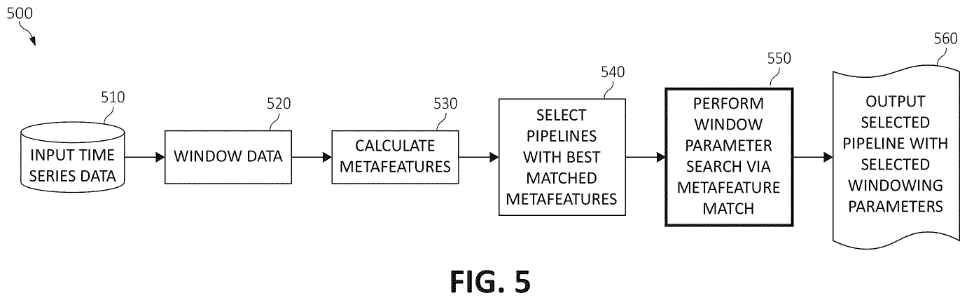

For further explanation, FIG. 5 is a block flow diagram depicting exemplary operations for performing lookback window parameter searching for timeseries automated AI machine learning (“ML”) systems (“AutoAI systems” or automated machine learning systems “auto ML system”) in a computing environment. In one aspect, one or more of the components, modules, services, applications, and/or functions described in FIGS. 1-4 may be used in FIG. 5. As shown, various blocks of functionality are depicted with arrows designating the blocks' of system 500 relationships with each other and to show process flow (e.g., steps or operations). Additionally, descriptive information is also seen relating each of the functional blocks' of system 500. With the foregoing in mind, the module blocks' of system 500 may also be incorporated into various hardware and software components of a system for providing enhanced lookback window searching in a computing environment in accordance with the present invention.

In some implementations, time series data may be received as input, as in block 510. One or more predefined pipelines may be created with predefined meta-features using window data with tunable parameters such as, for example, window type, window length, window skip, and the like, as in block 520. In block 530, meta-features may be calculated for windowed data. Meta-features may be compared and selected to find a closest matching pipeline (e.g., an optimized or best pipeline), as in block 540. In block 550, windowing parameters may be selected that result in windowed data whose meta-features are most similar to meta-features of the selected pipeline. In block 560, a selected pipeline with selected window parameters may be provided as output.

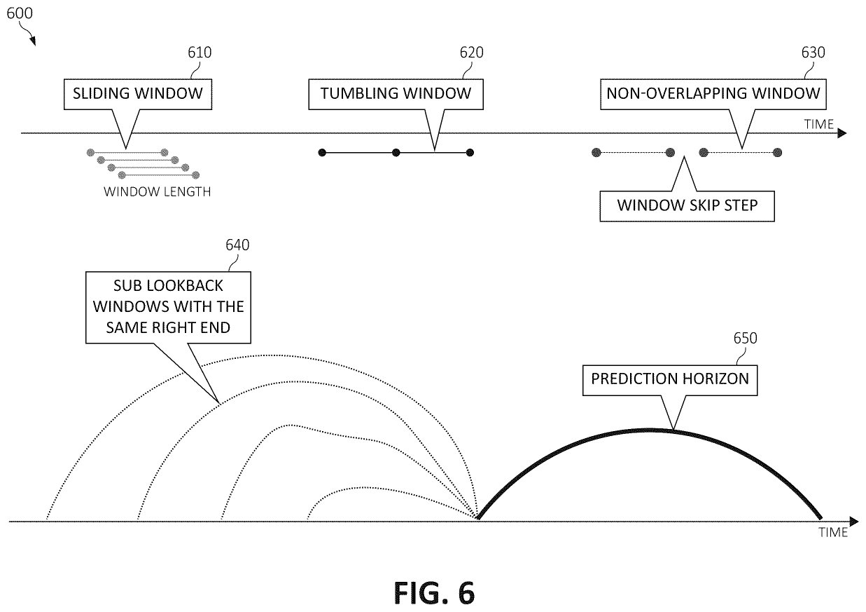

For further explanation, FIG. 6 is a diagram 600 depicting lookback window parameters in a computing environment by a processor in which aspects of the present invention may be realized. In one aspect, one or more of the components, modules, services, applications, and/or functions described in FIGS. 1-5 may be used in FIG. 6.

As depicted in FIG. 6, a timeline is depicted (e.g., current time) showing a sliding widow 510 having one or more moving lengths moving along the timeline. A tumbling widow 620 is also depicted. A non-overlapping window 630 is depicted with a window skip step.

A lookback window may be substituted with a similar right end, as in block 640. A predication horizon 650 may be used to segment time series data may be segmented using lookback window parameters.

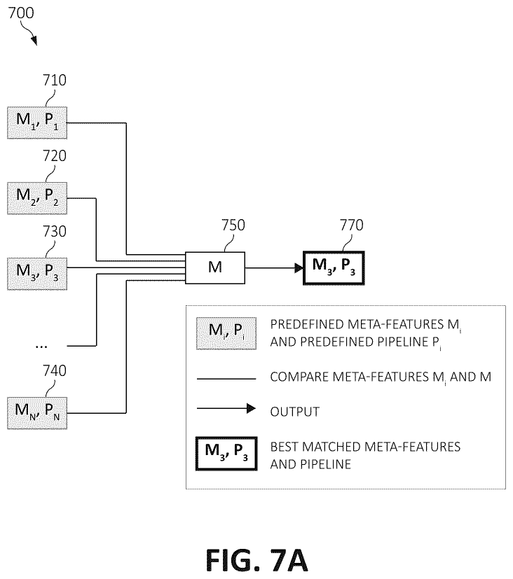

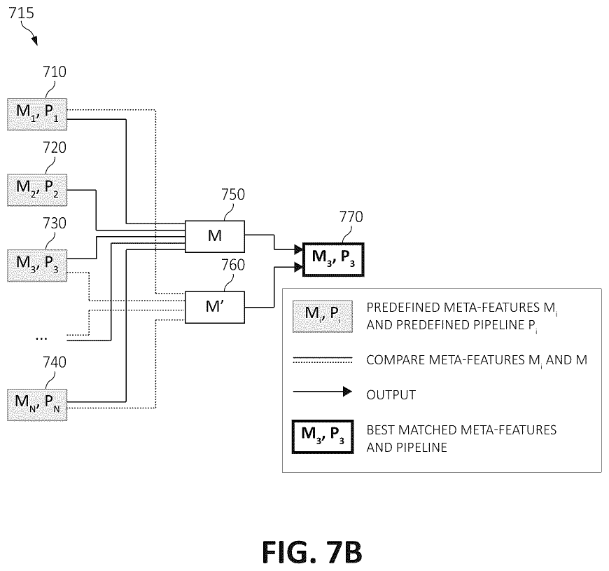

For further explanation, FIG. 7A is a diagram 700 depicting operations for providing meta feature matching to identify closest matching predefined meta-features and pipeline in a computing environment by a processor in which aspects of the present invention may be realized. FIG. 7B is a diagram 715 depicting operations for providing meta feature matching to identify closest matched pipeline in a computing environment by a processor in which aspects of the present invention may be realized. In one aspect, one or more of the components, modules, services, applications, and/or functions described in FIGS. 1-6 may be used in FIGS. 7A and 7B.

As depicted in FIG. 7A, one or more predefined meta-features (M₁) and predefined pipelines (P₁) such as, for example, predefined meta-features (M₁) and predefined pipelines (P₁) (“M₁, P₁”) 710, (“M₂, P₂”) 720, (“M₃, P₃”) 730, and (“MN, PN”) 740 may be used to compare one or more of the predefined meta-features (M₁) 710-740 with meta-features (M) 750. The matching meta-features may be used to find and provide as output best matched predefined meta-features (M₃) and predefined pipelines (P₃) (“M₃, P₃”) 770 (e.g., closest, optimized, or best matched meta-features and pipelines).

As depicted in FIG. 7B, one or more predefined meta-features (M₁) and predefined pipelines (P₁) such as, for example, predefined meta-features (M₁) and predefined pipelines (P₁) (“M₁, P₁”) 710, (“M₂, P₂”) 720, (“M₃, P₃”) 730, and (“MN, PN”) 740 may be used to compare one or more of the predefined meta-features (M₁) 710-740 with meta-features (M) 750 and meta-features (M′) 760. The matching meta-features may be used to find and provide as output best matched predefined meta-features (M₃) and predefined pipelines (P₃) (“M₃, P₃”) 770 (e.g., closest, optimized, or best matched meta-features and pipelines).

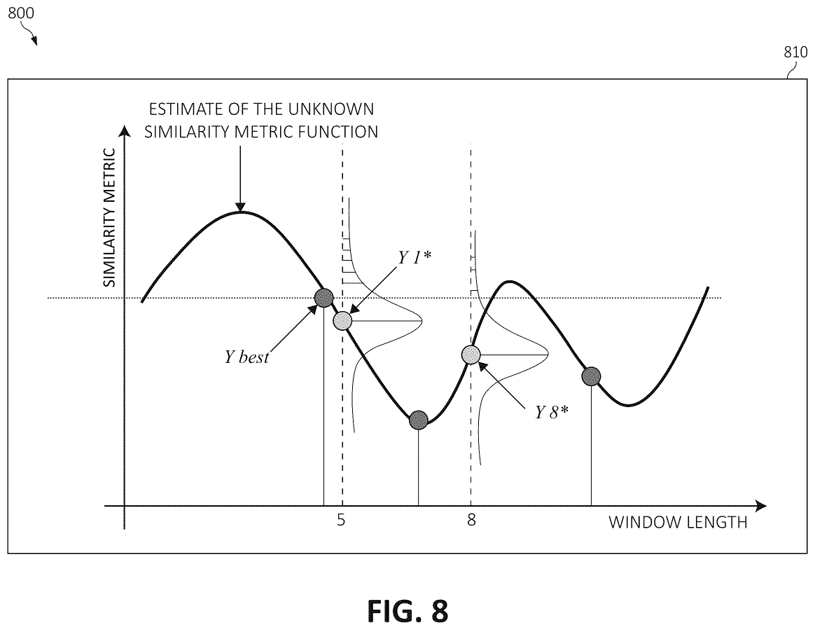

For further explanation, FIG. 8 is graph diagram 800 depicting exemplary operation for window length searching in Bayesian optimization in a computing environment by a processor in which aspects of the present invention may be realized. In one aspect, one or more of the components, modules, services, applications, and/or functions described in FIGS. 1-7A-7B may be used in FIG. 8.

As depicted in graph diagram 800, the y-axis depicts similarity metrics, and the x-axis depicts a window length. The curve indicates an estimate of an unknown similarity metric function for window length searching in Bayesian optimization using the following equations:

$${γ}_{i *} = \frac{{y}_{i *} - {y}_{best} - ξ}{{σ}_{i *}} , \qquad ( 1 )$$

$${EI}_{i *} = {σ}_{i *} [ {γ}_{i *} Φ ( {γ}_{i *} ) + 𝒩 ( {γ}_{i *} \vert 0 , 1 ) ] , \qquad ( 2 )$$

Where Φ(·) is a gaussian cumulative distribution function, N(·|0,1) is a Gaussian probability density function (“PDF”) with zero mean and 1 variance, and ξ is a free parameter to encourage exploration that may use small values such as, for example (e.g., 0.01).

Thus, the present invention may perform lookback window parameter search for timeseries AutoAI by 1) creating predefined pipelines with predefined meta-features, 2) segmenting timeseries data using lookback window parameters, 3) calculating meta-features for windowed data and find the predefined pipeline with the best matched predefined meta-feature, and 4) searching for lookback window parameters that result in windowed data whose meta-features are most similar to the selected meta-features.

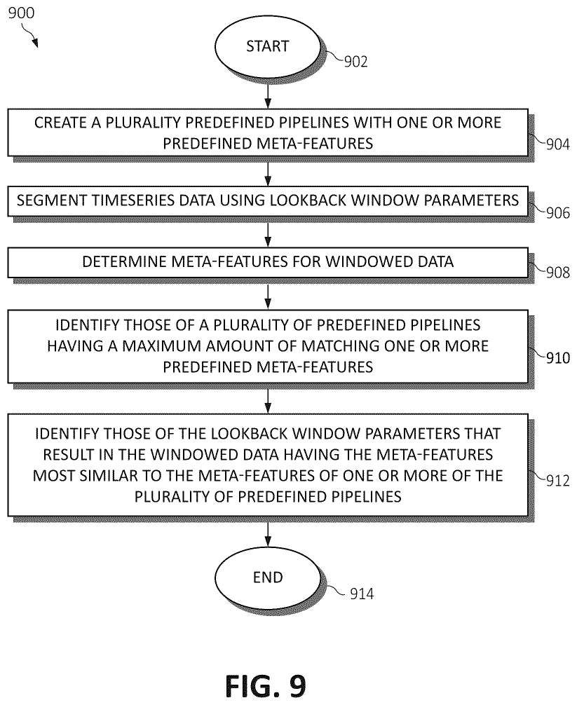

Turning now to FIG. 9, a method 900 for providing enhanced lookback window searching in a computing environment using a processor is depicted, in which various aspects of the illustrated embodiments may be implemented. The functionality 900 may be implemented as a method (e.g., a computer-implemented method) executed as instructions on a machine, where the instructions are included on at least one computer readable medium or one non-transitory machine-readable storage medium. The functionality 900 may start in block 902.

Predefined pipelines may be created with predefined meta-features, as in block 904. Time series data may be segmented using lookback window parameters, as in block 906. Meta-features may be determined for windowed data, as in block 908. Those of the predefined pipelines having a maximum amount of matching predefined meta-features may be determined, as in block 910. Those of the lookback window parameters that result in the windowed data having the meta-features most similar to the meta-features of one or more of the plurality of predefined pipelines may be identified, as in block 912. The functionality 900 may end, as in block 914.

In one aspect, in conjunction with and/or as part of at least one blocks of FIG. 9, the operations of method 900 may include each of the following. The operations of 900 may create the plurality predefined pipelines with the one or more predefined meta-features. The operations of 900 may compare the meta-features of the windowed data to identify those of the plurality of predefined pipelines matching the one or more predefined meta-features. The operations of 900 may use the lookback window parameters to identify those of the plurality of predefined pipelines having a maximum amount of matching one or more predefined meta-features.

The operations of 900 may identify one or more lookback window parameters having windowed data with meta-features similar to thee one or more meta-features. The operations of 900 may modify one or more of the lookback window parameters too adjust prediction targets. The operations of 900 may select the one or more of the plurality of predefined pipelines with selected lookback window parameters.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The descriptions of the embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for providing enhanced lookback window searching in a computing environment by one or more processors comprising:
segmenting timeseries data using lookback window parameters;
determining meta-features for windowed data;
identifying those of a plurality of predefined pipelines having a maximum amount of matching one or more predefined meta-features; and
identifying those of the lookback window parameters that result in the windowed data having the meta-features most similar to the meta-features of one or more of the plurality of predefined pipelines.

2. The method of claim 1, further including creating the plurality predefined pipelines with the one or more predefined meta-features.

3. The method of claim 1, further including comparing the meta-features of the windowed data to identify those of the plurality of predefined pipelines matching the one or more predefined meta-features.

4. The method of claim 1, further including using the lookback window parameters to identify those of the plurality of predefined pipelines having a maximum amount of matching one or more predefined meta-features.

5. The method of claim 1, further including identify one or more lookback window parameters having windowed data with meta-features similar to thee one or more meta-features.

6. The method of claim 1, further including modifying one or more of the lookback window parameters too adjust prediction targets.

7. The method of claim 1, further including selecting the one or more of the plurality of predefined pipelines with selected lookback window parameters.

8. A system for providing enhanced lookback window searching in a computing environment, comprising:
one or more computers with executable instructions that when executed cause the system to:
segment timeseries data using lookback window parameters;
determine meta-features for windowed data;
identify those of a plurality of predefined pipelines having a maximum amount of matching one or more predefined meta-features; and
identify those of the lookback window parameters that result in the windowed data having the meta-features most similar to the meta-features of one or more of the plurality of predefined pipelines.

9. The system of claim 8, wherein the executable instructions when executed cause the system to create the plurality predefined pipelines with the one or more predefined meta-features.

10. The system of claim 8, wherein the executable instructions when executed cause the system to compare the meta-features of the windowed data to identify those of the plurality of predefined pipelines matching the one or more predefined meta-features.

11. The system of claim 8, wherein the executable instructions when executed cause the system to use the lookback window parameters to identify those of the plurality of predefined pipelines having a maximum amount of matching one or more predefined meta-features.

12. The system of claim 8, wherein the executable instructions when executed cause the system to identify one or more lookback window parameters having windowed data with meta-features similar to thee one or more meta-features.

13. The system of claim 8, wherein the executable instructions when executed cause the system to modify one or more of the lookback window parameters too adjust prediction targets.

14. The system of claim 8, wherein the executable instructions when executed cause the system to select the one or more of the plurality of predefined pipelines with selected lookback window parameters.

15. A computer program product for providing enhanced lookback window searching in a computing environment, the computer program product comprising:
one or more computer readable storage media, and program instructions collectively stored on the one or more computer readable storage media, the program instruction comprising:
program instructions to segment timeseries data using lookback window parameters;
program instructions to determine meta-features for windowed data;
program instructions to identify those of a plurality of predefined pipelines having a maximum amount of matching one or more predefined meta-features; and
program instructions to identify those of the lookback window parameters that result in the windowed data having the meta-features most similar to the meta-features of one or more of the plurality of predefined pipelines.

16. The computer program product of claim 15, further including program instructions to create the plurality predefined pipelines with the one or more predefined meta-features.

17. The computer program product of claim 15, further including program instructions to compare the meta-features of the windowed data to identify those of the plurality of predefined pipelines matching the one or more predefined meta-features.

18. The computer program product of claim 15, further including program instructions to use the lookback window parameters to identify those of the plurality of predefined pipelines having a maximum amount of matching one or more predefined meta-features.

19. The computer program product of claim 15, further including program instructions to:
identify one or more lookback window parameters having windowed data with meta-features similar to thee one or more meta-features; and
modify one or more of the lookback window parameters too adjust prediction targets.

20. The computer program product of claim 15, further including program instructions to select the one or more of the plurality of predefined pipelines with selected lookback window parameters.
